(19) United States
(12) Patent Application Publication
(10) Pub. No.: US 2026/0262120 A1
(43) Pub. Date: Sep. 3, 2026

(54) METHODS FOR DISTRIBUTED MLD DESIGN AND PROCEDURES FOR UHR IN WLAN

(71) Applicant: InterDigital Patent Holdings, Inc., Wilmington, DE (US)

(72) Inventors: Xiaofei WANG, North Caldwell, NJ (US); Hanqing LOU, Syosset, NY (US); Joseph LEVY, Merrick, NY (US)

(73) Assignee: InterDigital Patent Holdings, Inc., Wilmington, DE (US)

(21) Appl. No.: 19/163,234

(22) PCT Filed: Mar. 8, 2024
(86) PCT No.: PCT/US2024/019114

§ 371 Date: Sep. 8, 2025

Related U.S. Application Data
(60) Provisional application No. 63/451,441, filed on Mar. 10, 2023.

(51) Int. Cl. H04W 76/15; H04W 8/22; H04W 60/04

(52) U.S. Cl. CPC H04W 76/15; H04W 8/22; H04W 60/04

(57) ABSTRACT

There may be a method, device, and/or system for distributed multi-link device design for ultra-high reliability situations. In some cases, a wireless receive transmit unit (WTRU), may receive an indication that an access point supports multi-AP operations. The WTRU may send a request for association to the access point, wherein the request for association includes a multi-AP operation element. The WTRU may receive a response to the request for association to the access point, wherein the response indicates a status of the multi-AP operation. The WTRU may send a multi-AP operation request, based on the status of the multi-AP operation. The WTRU may receive a multi-AP operation response. A single multi-link device may operate on multiple different channels, and a multi-AP operation, that uses more than one MLD or at least one MLD and another non-MLD, may operate on the same or overlapping channels.

### CROSS-REFERENCE TO RELATED APPLICATIONS

This application claims the benefit of U.S. Provisional Application No. 63/451,441, filed Mar. 10, 2023, the contents of which are incorporated herein by reference.

### BACKGROUND

Wireless communications, such as cellular and Wi-Fi technologies, are constantly improving. Wireless networking technology allows devices to connect to the internet and/or communicate with each other wirelessly within a certain range. They operate using specific radio frequencies, which for Wi-Fi originally only used one frequency range (e.g., 2.4 GHz), but Wi-Fi has recently expanded to additional frequencies, enabling more robust data transmission between devices like computers, smartphones, tablets, and routers. Wi-Fi and cellular networks are commonly used in homes, businesses, and public spaces, offering convenience and flexibility for internet access. Security measures, such as encryption protocols, help protect wireless communication networks from unauthorized access and data breaches. These technologies continue to evolve, with advancements in speed, range, and efficiency.

### SUMMARY

There may be a method, device, and/or system for distributed multi-link device design for ultra-high reliability situations. In some cases, a wireless receive transmit unit (WTRU), may receive an indication that an access point supports multi-AP operations. The WTRU may send a request for association to the access point, wherein the request for association includes a multi-AP operation element. The WTRU may receive a response to the request for association to the access point, wherein the response indicates a status of the multi-AP operation. The WTRU may send a multi-AP operation request, based on the status of the multi-AP operation. The WTRU may receive a multi-AP operation response. A single multi-link device may operate on multiple different channels, and a multi-AP operation, that uses more than one MLD or at least one MLD and another non-MLD, may operate on the same or overlapping channels.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system associated with one or more techniques described herein;

FIG. 1B is a system diagram illustrating an example wireless transmit/receive unit (WTRU) that may be used within the communications system illustrated in FIG. 1A according to one or more techniques described herein;

FIG. 1C is a system diagram illustrating an example radio access network (RAN) and an example core network (CN) that may be used within the communications system illustrated in FIG. 1A according to one or more techniques described herein;

FIG. 1D is a system diagram illustrating a further example RAN and a further example CN that may be used within the communications system illustrated in FIG. 1A according to one or more techniques described herein;

FIG. 2 illustrates an example of MMLD;

FIG. 3 illustrates an example of DMLD;

FIG. 4 illustrates an example of MXMLD;

FIG. 5 illustrates an example design of a multi-AP operation element;

FIG. 6 illustrates an example of multi-link traffic indication element format;

FIG. 7 illustrates an example of multi-link traffic indication control field format I;

FIG. 8 illustrates an example of multi-link traffic indication control field format II; and

FIG. 9 illustrates an example process according to one or more techniques described herein.

### DETAILED DESCRIPTION

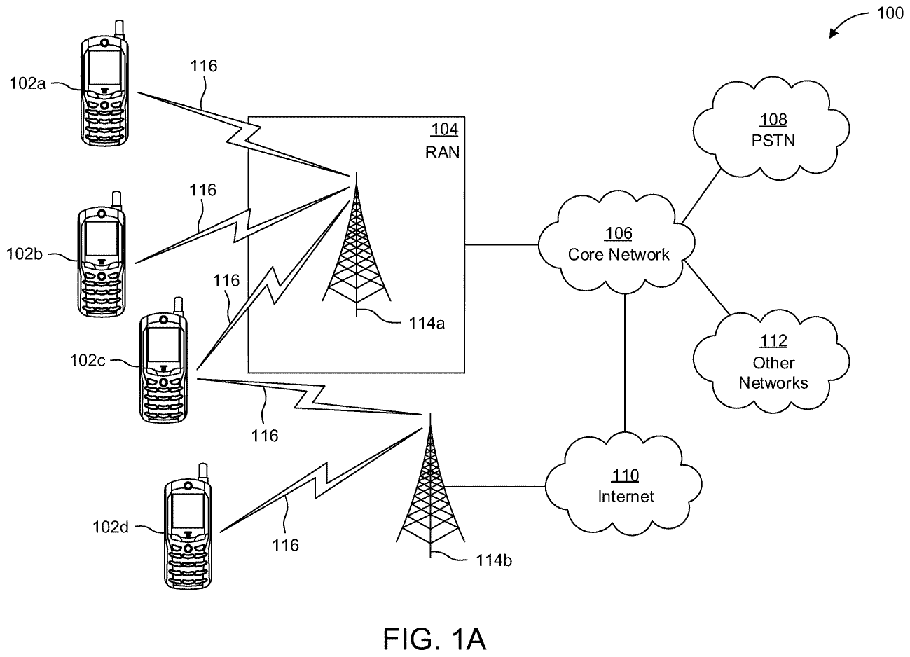

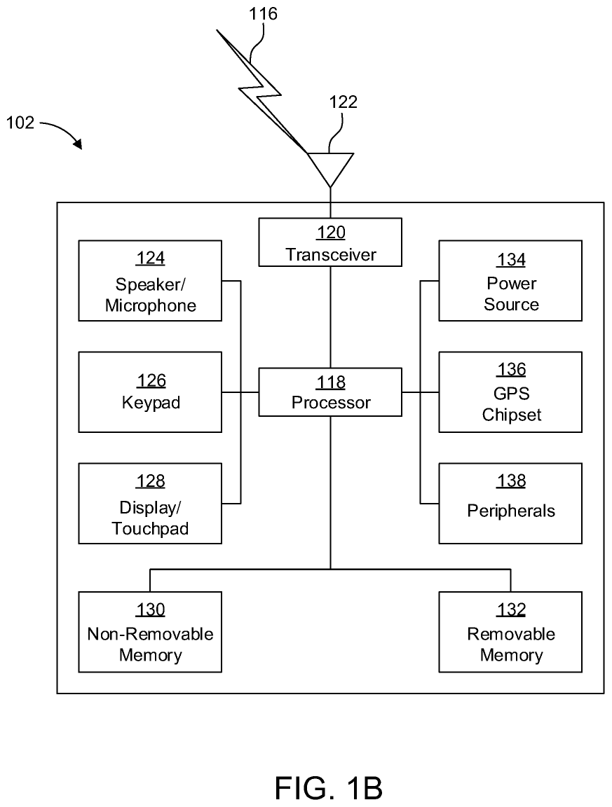

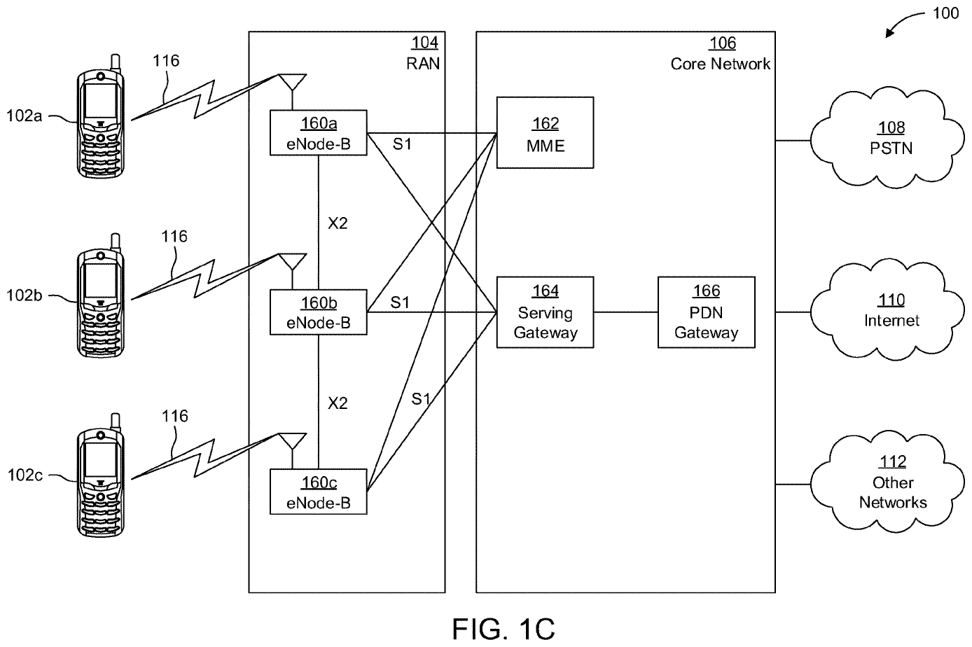

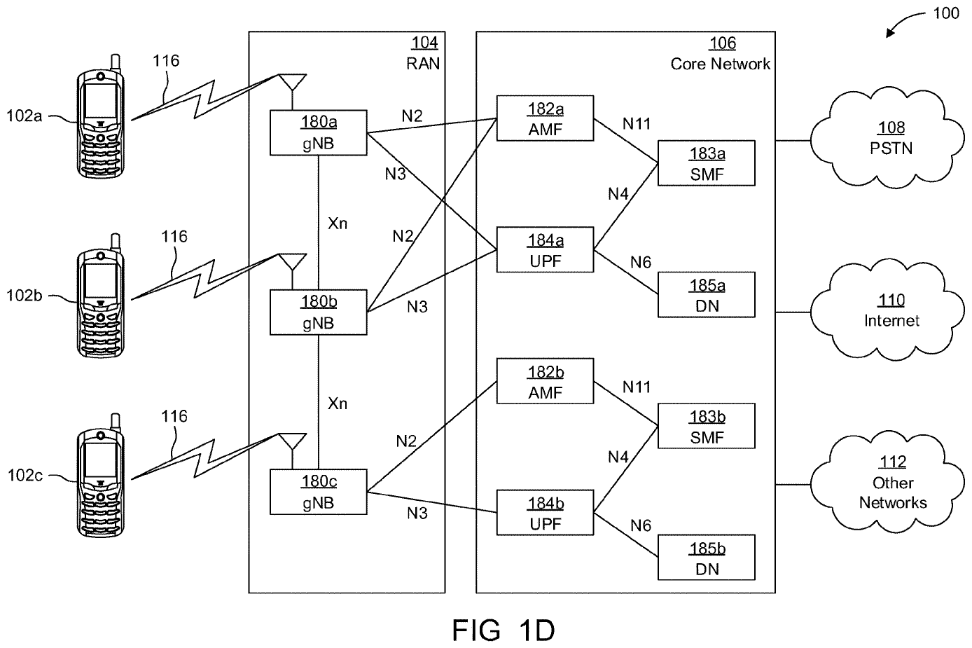

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

£ More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT, and time domain, processing are done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g. MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

In 802.11 Ultra High Reliability (UHR), UHR may be considered to build off of one or more aspects of 802.11be, and UHR may address improved reliability, support of low latency traffic and further increase peak throughput and improve efficiency of the IEEE 802.11 networks.

Coordinated Multi-AP (C-MAP) transmissions may include one or more schemes that may be a part of 802.11be and/or UHR: Coordinated Multi-AP OFDMA (co-OFDMA); Coordinated Multi-AP TDMA (co-TDMA); Coordinated Multi-AP Spatial Reuse (CSR); Coordinated beamforming/nulling (CBF); and/or, Joint Transmission (JTX).

In the context of coordinated multi-AP, several terminologies may be referenced: a Sharing AP is a specific type of AP (e.g., EHT AP) that obtains a TXOP and initiates the multi-AP coordination; a Shared AP is a specific type of AP (e.g., EHT AP) that is coordinated for the multi-AP transmission by the sharing AP; and/or, a AP candidate set, which is a set of one or more APs that can initiate or participate in multi-AP coordination (e.g., operation in a coordinated manner with one or more other APs).

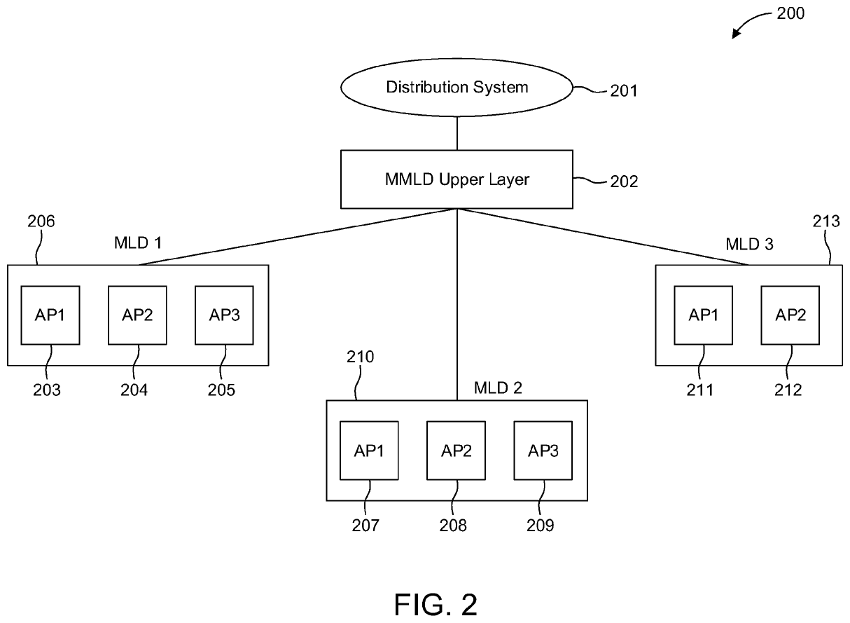

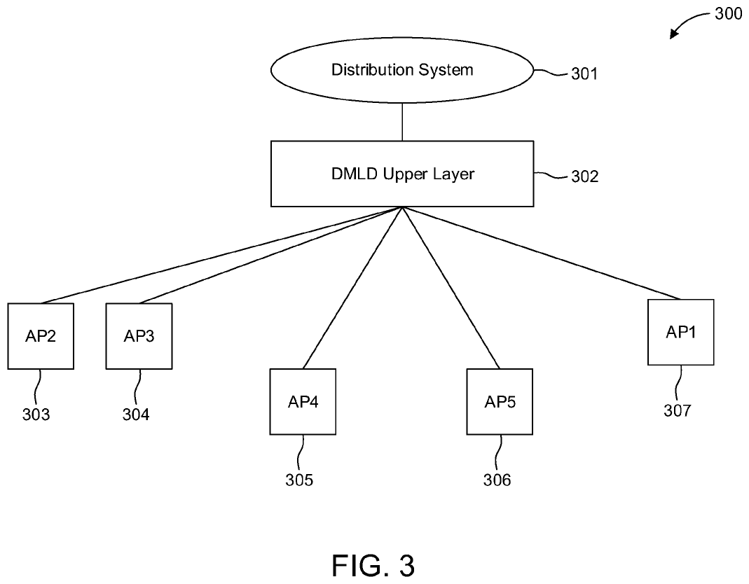

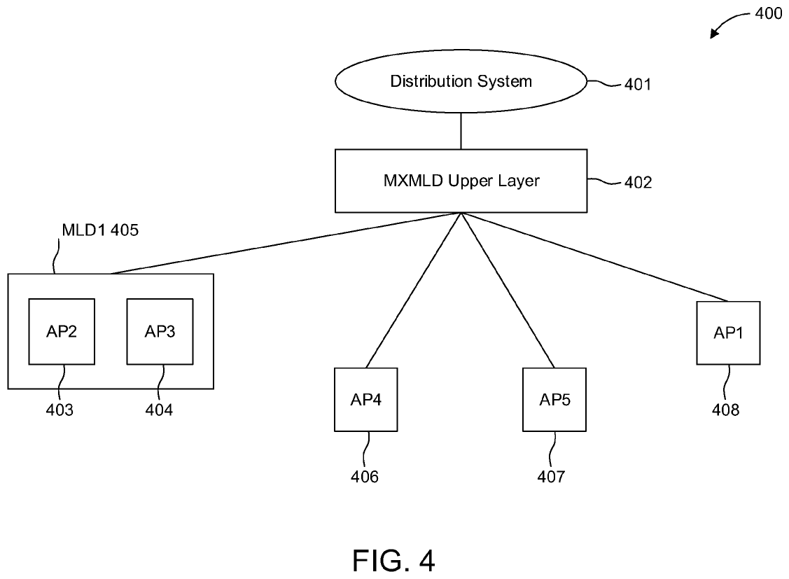

Multi-Multi-Link-Devices (MMLD) may comprise multiple APs and/or STAs. Each of the APs or STAs may be part of a physical device, which may be a Multi-link Device (MLD) and may comprise of one or more APs or STAs. An MMLD may be a logical entity that comprises multiple AP and/or STAs. An example of an AP MMLD may be shown in FIG. 2. In this example, an MMLD may comprise of the combination of one or more of the following: MMLD upper layer 202, MLD 1, MLD 2 and MLD 3 (e.g., 206, 210, and 213 respectively). In the example shown, each MLD comprises one or more AP, such as for MLD1 206 there are three APs (e.g., 203, 204, 205), for MLD2 210 there are three APs (e.g., 207, 208, 209), and for MLD3 213 there are 2 APs (e.g., 211, 213). One or more of the MMLD Upper Layer, MLD1, MLD2 and MLD3 may be located at the same physical location or at different locations. Each of the MLDs may be located in the same physical location or different physical location. A distributed AP MLD (DMLD) may be a logical entity that comprises APs that are located at different locations. An example of a DMLD may be shown in FIG. 3. In this example, a DMLD may comprise of the combination of one or more of the following: DMLD upper layer 302, AP1-AP5 (e.g., 303, 304, 305, 306, 307). One or more of the DMLD Upper Layer, AP1-AP5 may be located at the same physical location or at different locations. A mixed mode Multi-MLD (MXMLD) may be an MLD that comprises of one or more APs. Some of these APs may be a part of an MLD, while other of these APs may not be affiliated with a MLD other than the MMLD. An example of an MXMLD may be shown in FIG. 4. In this example, a MXMLD may comprise of the combination of one or more of the following: MXMLD upper layer 402, MLD1 405 (e.g., which comprises AP2 403 and AP3 404, AP1 408, AP4 406, and AP5 407. One or more of the MXMLD Upper layer, MLD1, AP1, AP4 and AP5 may be located at the same physical location or at different locations. As discussed herein, an MMLD, DMLD, and/or a MXMLD may be interchangeable, unless otherwise indicated. Further, these entities may represent different possible architectures for multi-AP operations, as discussed herein. In any of FIG. 2, FIG. 3, FIG. 4 there may be a distribution system (e.g., 201, 301, 401).

An AP multi-MLDs is an MMLD where the STAs affiliated with the MMLD may be APs. A non-AP multi-MLD is an MMLD where the STAs affiliated with the MMLD may be non-AP STAs. A mixed STA multi-MLD is an MMLD where some of the STAs affiliated with the MMLD may be APs while some of the STAs affiliated with the MMLD may be non-AP STAs. From the above, it may be understood that MMLD, DMLD, and MXMLD are all forms of multi-AP operation, which may be referenced interchangeable as described herein for multi-AP operations.

In some circumstances, multiple STAs and non-AP MLDs may choose to associate with one or more APs, or AP MLDs or with a MMLD during MMLD operations depending on its applications. In such circumstances, there is a need for to provide an efficient security and association procedure for STA and STA MLDs as well as for AP MLDs and multiple AP MLD for all potential multi-AP operation scenarios. One or more a multiple AP/STA MLD association procedures may address this issue, as described herein.

In some circumstances, multiple MLD operations may require communications between different APs and AP MLDs and one or more STAs or STA MLDs. The PPDUs using to carry data and management and control information may need to be suitable for such purposes. In such circumstances, there is a need for efficient PPDU designs for MMLD operations. One or more multiple MLD PPDU designs may address this issue, as described herein.

In some circumstances, there may be a multi-Link traffic indication element (e.g., for 802.11be or other systems) to allow an AP MLD to suggest a link to a non-AP MLD to retrieve its buffered traffic. The multi-link traffic indication element may comprise one or more per-link traffic indication bitmap subfields to indicate the link(s) the AP MLD suggests to the STA MLD to retrieve buffered traffic. The per-link traffic indication bitmap subfield may not include all possible link IDs, but instead it may include a subset of the link IDs. In legacy designs, it is not clear how a receiving STA can determine the starting link ID included in the per-link traffic indication bitmap subfield. One or more traffic indications may address this issue, as described herein.

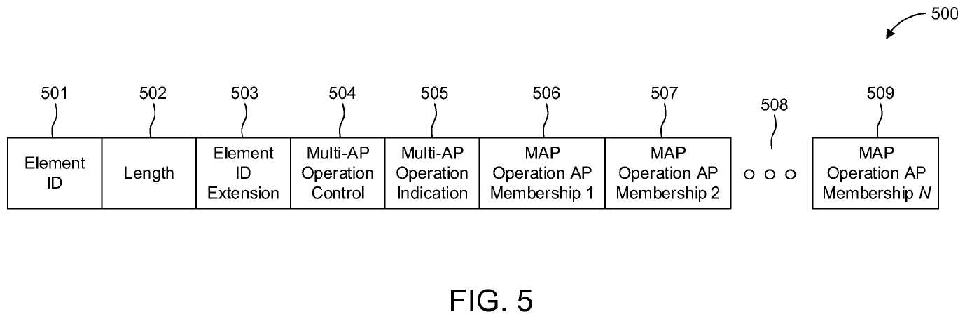

FIG. 5 illustrates an example design of an multi-AP operation element. The multi-AP operation element may include one or more fields. As shown, there is an Element ID 501, a Length 502, a Element ID Extension 503, a Multi-AP Operation Control 504, a Multi-AP Operation Indication 505, a Multi-AP Operation AP Membership 1 506, a Multi-AP Operation AP Membership 2 507, one or more additional fields 508 (e.g., such as duplicates of those shown within the illustrated example, and/or one or more other fields described herein), and/or a Multi-AP Operation AP Membership N 209 (e.g., where N is a number).

Generally, a multi-AP operation element may include one or more fields.

For example, the multi-AP operation element may include an Element ID & Element ID Extension, where the combination of the Element ID and Element ID Extension fields may indicate that the current element is a multi-AP operation element.

For example, the multi-AP operation element may include a length, where the length may indicate the length of the multi-AP operation element.

For example, the multi-AP operation element may include a multi-AP operation control field, where this field may include indication of the command related to one or more of the multi-ap operation, such as advertise, request to start one or more multi-AP operations, request to stop, or status code for the request of one or more multi-AP operations, such as SUCCESS, REJECTED, UNABLE_TO_SUPPORT, etc.

For example, the multi-AP operation element may include a multi-AP operation indication, where this field may include an indication of the support or request for one or more of the multi-AP operations, for example, Seamless BSS Transition or Seamless roaming, Joint Transmission, Redundant Transmission for Low latency and highly reliable traffic, Coordinated OFDMA, Coordinated TDMA, Coordinated Beamforming, etc. The implementation of this field may be in the form of a bitmap, where one or more bit is associated with a particular multi-AP operation. For example, a bit set to “1” at the position associated with Joint Transmission may indicate multi-AP joint transmission operation is supported or requested. Or one or more bits set to “1” at one or more positions in the bitmap may indicate that seamless BSS transition or seamless roaming, redundant transmission for low latency and highly reliable traffic, coordinated OFDMA, coordinated TDMA, TXOP sharing, coordinated spatial reuse, coordinated beamforming multi-AP operation is supported or requested.

For example, the multi-AP operation element may include 0 to n multi-AP operation AP membership fields, number 1 to n, if included. A multi-AP operation AP membership field may include an indication of one or more AP or links that may participate or is requested to participate in one or more multi-AP operations. In one example, a multi-AP operation AP membership field may be implemented as a bitmap, where each bit is associated with a link ID or an AP. A “1” at bit “i” implies that the AP associated with Link ID “i” participates or is requested to participate in one or more multi-AP operation. In one example, the mth multi-AP operation AP membership field indicates the APs or Link IDs that may participate or may be requested to participate in the mth multi-AP operations, which is associated with the bit “m” that is set to “1” or the mth “1” position in the bitmap that may be contained in the multi-AP operation indication field.

A multi-AP operation negotiation/association procedure (e.g., STA MMLD and AP multi-MLD or DMLD or MLD Association procedure, or the like as described herein) may require one or more steps as follows.

An AP, that may be affiliated with an MLD, MMLD, or DMLD, may advertise, in one or more frames that it transmits (e.g., beacons, short beacons, FILS discovery frames, other management or control, action frames, multi-AP beacons, etc. ,), support for one or more multi-AP operations (e.g., Seamless BSS Transition or Seamless transition, Joint Transmission, Redundant Transmission for Low latency and highly reliable traffic, Coordinated OFDMA, TXOP Sharing, Coordinated Spatial Reuse, Coordinated TDMA, Coordinated Beamforming, etc.) (e.g., support may be shown by setting one or more bits or include indications in the multi-AP operation indication). The AP may indicate the APs or Link IDs of the APs that may participate in one or more multi-AP Operations in (e.g., the multi-AP operation AP membership field). In one example, one multi-AP operation AP membership field is included and the Link IDs of the AP indicated in the field implies that all the APs indicated can participate in all multi-AP operations advertised in the multi-AP operation indication field. In another example, an multi-AP operation AP membership field is included for each multi-AP operations indicated in the multi-AP operation indication field and only the Link IDs or APs indicated in the multi-AP operation AP membership “m” field may support the mth multi-AP operations indicated in the multi-AP operation indication field.

A STA, that may be affiliated with a non-AP MLD, may request association by sending an association request frame to an AP that is affiliated with an MLD, MMLD, or DMLD, and may request multi-AP operations by including a multi-AP operation element in the association request frame. The STA may include an indication of request (e.g., in the multi-AP operation control field), and then the requested multi-AP operations in the multi-AP operation indication, and/or the requested APs or Link IDs of APs that are requested to participate in the requested multi-AP operations. The STA may include a multi-AP operation element in the common info field of the basic or multi-AP multi-link element of the association request frame it transmits, for example to request multi-AP operation support from the receiving AP or from all requested APs that may be associated with the same MLD or MMLD or DMLD. Alternatively or additionally, the STA may include a multi-AP operation element in one or more of the per-STA profile field in the basic or multi-AP multi-link element to request multi-AP operation support from one or more APs. The multi-AP operation element contained in the common info field and/or in the one or more per-STA profile field may be the same (e.g., to request the same multi-AP operations) or different (e.g., to request different multi-AP operations). From the above, it may be understood that a STA may send a message to an AP indicating support for and/or requesting multi-AP operation.

An AP, which may be affiliated with an AP MLD, MMLD, or DMLD, that receives such an association request frame from the STA, may respond by sending an association response frame to the STA, and may indicate the status of the requested multi-AP operations by including a multi-AP operation element in the association response frame. The AP may include an indication of status code of the request (e.g., in the multi-AP operation control field), such as SUCCESS, REJECT, or UNABLE_TO_SUPPORT, and if the status code is SUCCESS, then the AP may indicate the multi-AP operations to be started in the multi-AP operation indication, and/or the APs or Link IDs of APs that may participate in the multi-AP operations. The multi-AP operation element may also include a timer at which the multi-AP operations are expected to start. The AP may include a multi-AP operation element in the common info field of the basic or multi-AP multi-link element of the association response frame it transmits, for example to respond to multi-AP operation support request by the receiving AP or by all requested APs that may be associated with the same MLD or MMLD or DMLD. Alternatively or additionally, the AP may include a multi-AP operation element in one or more of the per-STA profile field in the basic or multi-AP multi-link element to respond to the multi-AP operation support request by one or more APs. The multi-AP operation element contained in the common Info field and/or in the one or more per-STA profile field may be the same (e.g., to respond to the same multi-AP operations request) or different (e.g., to respond to different multi-AP operations). If an multi-AP operation element was included in one or more of the per-STA profile in the association request frame, then a multi-AP operation element may also include in the corresponding per-STA profile in the association response frame.

An AP, which may be affiliated with an MLD, MMLD, MXMLD, DMLD, that is transmitting an association response may assign or indicate in the association response frame that STAs that are affiliated with a non-AP MLD are assigned on the same or overlapping channels, especially if it has indicated in the association response frame that one or more multi-AP operation requests was successful, such as seamless BSS transition or seamless roaming, joint transmission, redundant transmission for low latency and highly reliable traffic, coordinated OFDMA, TXOP sharing, coordinated spatial reuse, coordinated TDMA, coordinated beamforming. Said another way, more than one AP (e.g., MLD, non-MLD, etc.) may be operate on the same or overlapping channels for multi-AP operation.

A STA, which may be affiliated with an non-AP MLD and is already associated with an AP MLD, MMLD, or DMLD, may request to start or stop one or more multi-AP operations by including a multi-AP operation element in a frame sent to an AP affiliated with the AP MLD, MMLD or DMLD, such as a multi-AP operation request frame. The STA may include an indication of request to start or to stop (e.g., in the multi-AP operation control field), and then the requested multi-AP operations in the multi-AP operation indication, and/or the requested APs or Link IDs of APs that are requested to participate or currently participating in the requested multi-AP operations.

An AP that may be affiliated with an AP MLD, MMLD, or DMLD, receiving such multi-AP operation request frame from an associated STA or a STA affiliated with an associated non-AP MLD, may respond by sending a multi-AP operation response frame to the STA and may indicate the status of the requested multi-AP operations by including multi-AP operation element in the multi-AP operation response frame. The AP may include an indication of status code of the request (e.g., in the multi-AP operation control field), such as SUCCESS, REJECT, or UNABLE_TO_SUPPORT, and if the status code is SUCCESS, then the AP may indicate the multi-AP operations to be started or to be stopped in the multi-AP operation indication, and/or the APs or Link IDs of APs that may participate in the multi-AP operations.

In some cases, a multi-MLD AP management entity may provide coordination and management of the MLD APs that are operating together to provide multi-AP services to non-AP MLDs, multi-MLD services to non-AP multi-MLD aware non-AP devices, multi-MLD services to non-AP MLD device (e.g., that is not multi-MLD aware) and multi-MLD services to non-AP STAs (e.g., that are not multi-MLD or MLD aware). Coordination may include one or more aspects.

For example, coordination may include an operating frequency of the RF links provided by the MLD APs.

For example, coordination may include synchronization of the transmission of PPDUs on the RF links (for any or all of the following): Joint transmission, where PPDUs transmitted by different MLD APs are transmitted so that the receiving non-AP MLD receives the summation of the PPDUs transmitted by the MLD APs; Distributed MIMO transmission, where the PPDUs transmitted by different MLD APs are transmitted so that the receiving non-AP MLD receives them as MIMO transmissions that it can combine; MAC level PPDU combining, where the PPDUs transmitted by different MLD APs are received as independent PPDUs that can be combined at the MAC layer; TWT coordination-coordinating support of a non-AP STA's or non-AP MLD's TWT for the APs supporting the multi-MLD; and/or, Power management coordination, which may include coordinating the transmission and timing of AP DTIM beacons for multi-MLDs and MLDs, and/or coordinating the non-AP MLD awake channel(s) and target AP(s).

For example, coordination may include combining received PPDUs from a non-AP MLD received on an AP affiliated with the multi-MLD or MLD (e.g., that were received using any or all of the following): Joint reception; Distributed MIMO reception; and/or, MAC level PPDU combining.

For example, coordination may include management of security context and keys. In one instance, multi-MLDs using MLD pairwise keys may use a single pairwise key for all the MLDs in the multi-MLD. The MLD MAC address used in these transmissions is the MLD MAC address that was used to establish the pairwise key. This allows a non-AP MLD to establish a single pairwise key for all data frames exchanged in the multi-MLD. The management entity may coordinate the MLD MAC addresses and associated keys in the multi-MLD. The management entity may also coordinate the MLD MAC addresses and associated keys with other multi-MLDs, MLDs, and APs to support the mobility of the non-AP multi-MLD, non-AP MLD, or non-AP STA in the service area supported by the management entity. In another instance, for group addressed frames the management entity may coordinate which affiliated APs will transmit the frames and which keys (GTK/IGTK/BIGTK) will be used for transmission. Initially, this information may be provided to the non-AP MMLDs, non-AP MLDs, and non-AP STAs via a 4-way handshake and/or a two-way handshake. The management entity may inform associated non-AP M MLDs, MLDs, or STAs where group addressed frames will be transmitted and the keys associated with the transmission. The management entity will update the group addressed keys and transmitting APs whenever changes or updates are made via an affiliated AP. This information may be updated via management frames and/or a two-way handshake, or a 4-way handshake. All information related to keys should use a secure method of transmission.

For example, coordination may include management of affiliated AP group address transmission. For group addressed frames the management entity may coordinate which affiliated APs will transmit the frames. To reduce redundant group addressed frame transmission the management entity may limit the affiliated APs that will send the group addressed frames. When the affiliated APs are limited, the management entity may ensure that the non-AP MMLDs, non-AP MLDs, and non-AP STA are aware of which affiliated APs will be making these transmissions and that the non-AP MMLDs, non-AP MLDs, and non-AP STAs are configured to be able to receive the transmissions they desire (e.g., a STA that is a member of a group that wishes to receive group addressed transmissions). The management entity may inform associated non-AP M MLDs, MLDs, or STAs where group addressed frames will be transmitted (e.g., which affiliated APs will be transmitting the group addressed frames). Note, this may also restrict the choice of which affiliated APs will be transmitting the frames as some non-AP MMLDs, MLDs, or STAS may not be capable of receiving transmissions from all of the APs affiliated with the AP MMLD.

For example, coordination may include management of MAC addresses. MMLDs may have multiple MAC addresses to manage, such as: MLD MAC addresses; affiliated AP MAC addresses; and/or, affiliated STA MAC addresses.

MLD MAC addresses: in an MLD there is a single MLD MAC address pair for data frame exchanges between the non-AP MLD and the AP MLD. This single MAC address may be extended to all exchanges between the non-AP MMLD and the AP MMLD or a non-AP MLD and the AP MMLD.

Multiple MLD MAC addresses in an MMLD: it is also possible to establish MLD MAC address pairs for data frame exchange for use in each of the MLDs that make up the MMLD. Using different MLD MAC address pairs for each MLD of the MMLD may require the management entity to manage these MAC addresses and inform the various MLDs what these MLD are and what the associated security context is for each MLD MAC address used in the MMLD. The sharing of MLD MAC addresses and security context may be essential for some MMLD features (e.g., joint reception, distributed MIMO).

Affiliated AP MAC addresses: each affiliated AP in an MLD has a “transmit” MAC address (e.g., this MAC address may be the same or different from the MLD MAC address). The management entity may manage these addresses. The management entity may coordinate them so that various MMLD features can be supported. For example, the management entity may provide a set of affiliated APs that are configured to transmit on the same channel to use the same MAC address for distributed MIMO transmissions. Alternatively, the management entity may choose to use different MAC addresses for each affiliated AP to support non-AP STAs that would be confused by transmissions from different APs having the same MAC address.

Affiliated non-AP MAC addresses: each affiliated non-AP STA in an MLD has a “transmit” MAC address (this MAC address may be the same or different from the MLD MAC address). The management entity may manage these addresses. The management entity may coordinate these MAC addresses to simplify affiliated AP reception of transmissions from a non-AP MMLD or MLD (e.g., it may simplify AP MMLD reception if all affiliated STAs of the non-AP MMLD or MLD use the same transmitted MAC address, as address one filtering can be used).

For example, coordination may include transparency of a MMLD to a non-AP MLD or MMLD. The receiving non-AP MLD or MMLD need not be aware that it is receiving PPDUs sent by multiple MLD APs.

If the transmissions of affiliated APs of different MLDs that are operating on the same channel and can be simultaneously heard by an affiliated STA of a non-AP MLD coordinate their transmissions so that they are received at the affiliated STA as a joint transmission, then the affiliated STA may receive the transmission as if it was transmitted from a single affiliated AP. This requires the affiliated APs to transmit identical transmissions to the affiliated STA that will add constructively.

If the transmissions of affiliated APs of different MLDs that are operating on the same channel and can be simultaneously heard by an affiliated STA of a non-AP MLD coordinate their transmissions so that they are received at the affiliated STA as MIMO transmission, then the affiliated STA may receive the transmission as if it was transmitted from a single affiliated AP. This requires the affiliated APs to transmit coordinated MIMO transmissions from their antennas to the affiliated STA that can be received as a MIMO transmission.

If the transmissions of affiliated APs of different MLD are on different channels that can be heard by affiliated STAs of a non-AP MLD or MMLD, then these transmissions may be received by the non-AP MLD or MMLD as if they were transmitted by a single MLD. This requires the affiliated APs transmit using the same MLD MAC address and that the receiving MLD is aware of the transmit MAC addresses of the transmitting affiliated APs.

For example, coordination may include reception of non-AP MLDs and Non-AP STAs transmissions by an MMLD. The reception of transmissions from an affiliated STA of a non-AP MMLD, non-AP MLD, or non-AP STA may be received by any affiliated AP of an AP MMLD. Depending on the type of transmission the affiliated APs may coordinate through the management entity to combine or otherwise process these received transmissions. The management entity may process the received transmissions or share the received transmission with one or more of the affiliated APs to process.

In some cases, as part of multi-AP operation (e.g., in a MMLD PPDU), an AP affiliated with an MLD or MMLD or DMLD may transmit a PPDU to a STA or a STA affiliated with a non-AP MLD using a BSS Color in PHY or MAC preamble (e.g., in U-SIG, or UHR-SIG or EHT-SIG, or MAC header, or other parts of the PPDU), in one or more scenarios.

For example, in one scenario if the AP that is affiliated with an MLD or MMLD or DMLD, and the PPDU is transmitted as a part of transmission in a multi-AP operation scenario that involves a same channel operation such as joint transmission, redundant transmission of low latency or high reliability packet, or BSS transition support, then the BSS Color in the PPDU may be set to equal to MLD BSS Color, or MMLD BSS Color, or DMLD BSS Color. The receive address (RA) may be set to the MAC address of the STA that may be affiliated with the non-AP MLD operating on the same channel. The transmitter address (TA) may be set to the MLD or MMLD or DMLD MAC address. The BSSID or address 3 may be set to the MLD, MMLD or DMLD MAC address. The U-SIG, or UHR-SIG, or EHT-SIG, or PHY preamble of the PPDU may also contain an indication of multi-AP operation that the PPDU is part of, such as joint transmission, redundant transmission of low latency or high reliability packet, or BSS transition support.

For example, in one scenario if the AP that is affiliated with an MLD or MMLD or DMLD, and the PPDU is transmitted as a part of transmission in a multi-AP operation scenario that involves a same channel operation such as coordinated OFDMA, coordinated beamforming, coordinated TDMA, the BSS Color may set to equal to MLD BSS Color, or the BSS Color of the BSS of the AP. The receive address (RA) may be set to the MAC address of the STA that may be affiliated with the non-AP MLD operating on the same channel. The transmitter address (TA) may be set to the MAC address of the AP or the MLD or MMLD or DMLD MAC address (e.g., in a where two APs are transmitting as part of multi-AP operation as described herein, both APs would have the same transmitter address). The BSSID or address 3 may be set to the MLD, MMLD or DMLD MAC address. The U-SIG, or UHR-SIG or EHT-SIG or PHY preamble of the PPDU may also contain an indication of multi-AP operation that the PPDU is part of, such as coordinated OFDMA, coordinated beamforming, coordinated TDMA transmission, etc.

For a non-AP STA or a STA affiliated with a non-AP MLD, or MMLD, or DMLD, the STA may filter any received PPDUs based on the multi-AP operation scenarios that is participating.

For example, if the STA is currently participating in a multi-AP operation scenario that involves a same channel operation such as joint transmission, redundant transmission of low latency or high reliability packet, or BSS transition support, it may filter based on the BSS Color in the PPDU and may continue to receive if the BSS Color is set to equal to MLD BSS Color, or MMLD BSS Color, or DMLD BSS Color, or if the receive address (RA) is set to the MAC address of the STA that may be affiliated with the non-AP MLD operating on the same channel, and/or if the transmitter address (TA) is set to the MLD or MMLD or DMLD MAC address, or if the BSSID or address 3 is set to the MLD, MMLD or DMLD MAC address, and/or if the U-SIG, or UHR-SIG or EHT-SIG or PHY preamble of the PPDU also contains an indication of multi-AP operation that the PPDU is part of, such as joint transmission, redundant transmission of low latency or high reliability packet, or BSS transition support.

For example, if the STA is participating in a multi-AP operation scenario that involves a same channel operation such as coordinated OFDMA, coordinated beamforming, coordinated TDMA, then it may filter received PPDUs based on the BSS Color if the BSS Color is equal to MLD BSS Color, or the BSS Color of the BSS of the AP, or if the receive address (RA) is set to the MAC address of the STA that is affiliated with the non-AP MLD operating on the same channel, or if the transmitter address (TA) is set to the MAC address of the AP or the MLD or MMLD or DMLD MAC address, and/or if the BSSID or address 3 is set to the MLD,MMLD or DMLD MAC address, and/or if the U-SIG, or UHR-SIG or EHT-SIG or PHY preamble of the PPDU also contains an indication of multi-AP operation that the PPDU is part of, such as coordinated OFDMA, coordinated beamforming, coordinated TDMA transmission.

If a non-AP STA or a STA affiliated with a non-AP MLD, MMLD or DMLD, the STA may transmit a PPDU to an AP or an AP affiliated with a AP MLD, MMLD, or DMLD using a BSS Color in PHY or MAC preamble (e.g., in U-SIG, or UHR-SIG or EHT-SIG, or MAC header, or other parts of the PPDU), in one or more scenarios.

For example, in one scenario if the STA transmits the PPDU as a part of transmission in a multi-AP operation scenario (e.g., that involves a same channel operation such as redundant transmission of low latency or high reliability packet, or BSS transition support), then the BSS Color in the PPDU may be set to equal to MLD BSS Color, or MMLD BSS Color, or DMLD BSS Color. The receive address (RA) may be set to the MLD/MMLD/DMLD MAC address of the MLD/MMLD/DMLD with which the STA or non-AP MLD is associated. The transmitter address (TA) may be set to the non-AP MLD or MMLD or DMLD MAC address. The BSSID or address 3 may be set to the AP MLD, MMLD or DMLD MAC address. The U-SIG, or UHR-SIG or EHT-SIG or PHY preamble of the PPDU may also contain an indication of multi-AP operation that the PPDU is part of, such as redundant transmission of low latency or high reliability packet, or BSS transition support.

For an AP or an AP that is affiliated with an AP MLD, MMLD or DMLD STA, the AP may filter any received PPDUs based on the multi-AP operation scenarios that is participating, such as: if the AP is currently participating in a multi-AP operation scenario that involves a same channel operation such as joint transmission, redundant transmission of low latency or high reliability packet, or BSS transition support, then it may filter based on the BSS Color in the PPDU and may continue to receive if the BSS Color is set to equal to MLD BSS Color, or MMLD BSS Color or DMLD BSS Color, or if the receive address (RA) is set to the MAC address of the AP or the MLD or MMLD or DMLD MAC address, and/or if the transmitter address (TA) may be set to the MAC address of the STA or non-AP MLD MAC address, or if the BSSID or address 3 is set to the MLD, MMLD or DMLD MAC address, and/or if the U-SIG, or UHR-SIG or EHT-SIG or PHY preamble of the PPDU also contains an indication of multi-AP operation that the PPDU is part of, such as joint transmission, redundant transmission of low latency or high reliability packet, or BSS transition support.

In some cases, an AP MLD may use an enhanced multi-link traffic indication element and TIM element carried in a beacon frame to recommend a non-AP MLD to use one or more enabled links to retrieve individually addressed buffered BU(s). Or an AP MLD may also use the enhanced multi-link traffic indication element and an associated ID (AID) bitmap element in a link recommendation frame to recommend a non-AP MLD to use one or more enabled links for all exchanges both for DL and UL. The AIDs identified by the AID Bitmap element may be used to indicate the AID(s) of the non-AP MLD(s). The AP's indication may be carried in a broadcast or a unicast frame. In a more general case, the element may be carried in other existing or newly defined control or management frames, such as an alternative beacon frame, link recommendation beacon frame, etc.

The enhanced multi-link traffic indication element may carry a Link ID offset subfield to indicate the minimum link ID where the first bit in the per-link traffic indication bitmap in the enhanced multi-link indication element may be corresponding to.

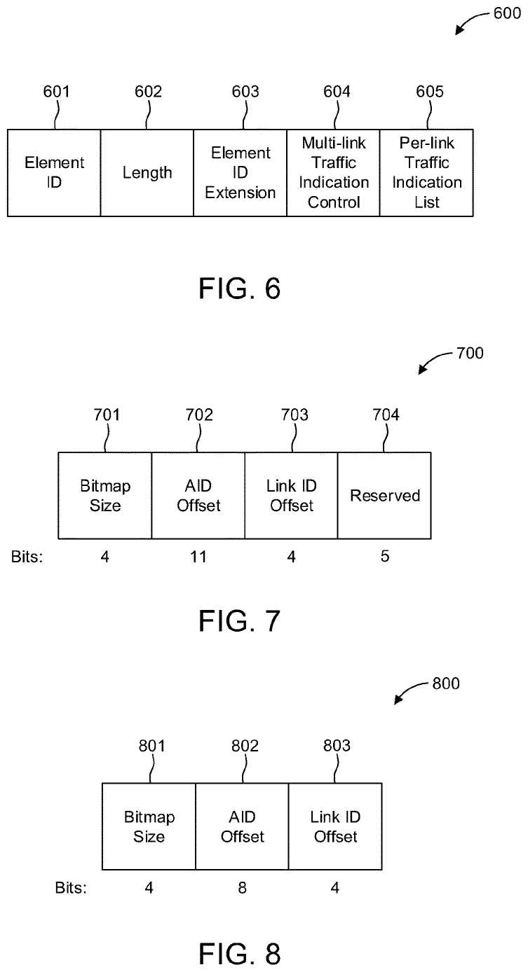

In one method, the enhanced multi-link traffic indication element may (re)use the format, a may be new but similar to the format, of multi-link traffic indication element defined in 802.11be, and modify one or more fields/subfields to include the Link ID offset field. For example, the multi-link traffic indication element may be the same as defined in 802.11be (as shown in FIG. 6), however, the multi-link traffic indication control field may be modified/improved.

FIG. 6 illustrates an example of a multi-link traffic indication element format. As shown, the multi-link traffic indication element format may include one or more fields, such as an Element ID 601, a Length 602, an Element ID Extension 603, a Multi-Link Traffic Indication Control 604, and/or a Per-Link Traffic Indication List 605.

The multi-link traffic indication control field may be modified to include the Link ID Offset subfield. In one method, the length of the multi-link traffic indication control field may be increased from two octets to three octets. Additionally, the Link ID Offset subfield may use four or more bits to indicate the link ID of the starting bit in the per-link traffic indication bitmap. An example modified multi-link traffic indication control field is shown in FIG. 7. Note, the numbers of bits for each subfield shown here are just an example, meaning the number of bits could be any number.

FIG. 7 illustrates an example of a modified multi-link traffic indication control field format I. As shown, the example of the modified multi-link traffic indication control field format may include one or more sub-fields/fields, such as a Bitmap Size 701, an AID Offset 702, a Link ID Offset 703, and/or a Reserved sub-field 704 (e.g., the Reserved subfield may be a duplicate of one or more of the other sub-fields/fields shown within the illustrated example, and/or one or more other sub-fields/fields described herein).

In one method, the length of the multi-link traffic indication control field may be the same as defined in 802.11be (e.g., two octets). An example of a multi-link traffic indication control field format is given in FIG. 8. The AID offset subfield is modified to indicate an octet numbered n of the traffic indication virtual bitmap carried either in TIM element or AID bitmap element. The equation k=8n may be used to calculate the bit numbered k of the traffic indication virtual bitmap. Note, the numbers of bits for each subfield shown here are just an example, meaning the number of bits could be any number.

FIG. 8 illustrates an example of a modified multi-link traffic indication control field format II. As shown, the example of the modified multi-link traffic indication control field format may include one or more sub-fields/fields, such as a Bitmap Size 801, an AID Offset 802, a Link ID Offset 803.

Alternatively, the per-link traffic indication bitmap may be defined to always start from Link ID 0. In this way, the bitmap size subfield carried in the multi-link traffic indication control field may be set to value m, where m is equal to the largest link ID value among all intended AIDs included in the multi-link traffic indication element. For example, the multi-link traffic indication element may target intended non-AP MLDs with AID from 5 to 7. For non-AP MLD with AID 5, the enabled or active links are Link ID 2, 3, 4. For non-AP MLD with AID 6, the enabled or active links are Link ID 1, 3. For non-AP MLD with AID7, the enabled or active links are Link ID 2, 6. Then m may be set to 6, and thus each per-link traffic indication bitmap subfield contains 7 bit corresponding to link ID 0 to 6.

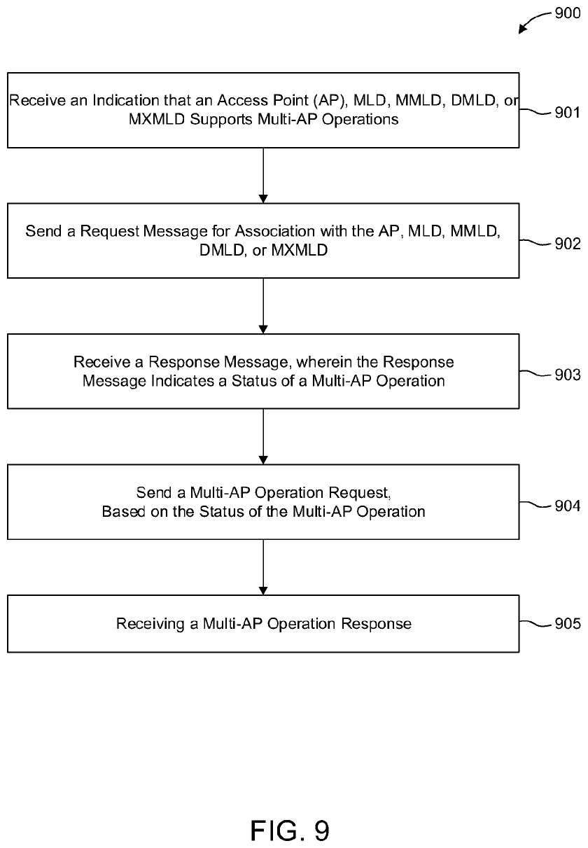

FIG. 9 illustrates an example process according to one or more techniques herein. As shown, at 901 the STA may receive an advertisement from one or more APs that multi-AP operation is possible. Multi-AP operation, as described herein, may include coordinated action between at least two APs, such as a first AP and a second AP. The first AP may be associated with a first MLD, MMLDs, DMLDs or MXMLDs, and the second AP may be associated with the first MLD, MMLDs, DMLDs or MXMLDs or a second MLD, MMLDS, DMLDs or MXMLDs, depending on the given scenario (e.g., MMLD, DMLD, MXMLD etc.). At 902, the STA may send a request for association to at least one of the one or more APs, MLDs, MMLDs, DMLDs or MXMLDs, wherein in one case the request for association includes a multi-AP operation element. At 903, the STA may receive a response to the request for association from the access point (e.g., the response may be about the association with the AP, MLD, MMLD, DMLD, or MXMLD), wherein the response indicates a status of the multi-AP operation. At 904, the STA may send a multi-operation request, based on the status of the multi-AP operation. At 905, the WTRU may receive a multi-operation response. At some point later, the STA may be involved in an multi-AP operation, where at least two APs are involved. In one case, the STA may receive at least two transmissions, a first transmission from a first AP and a second transmission from a second AP. In one case, the two transmissions (e.g., as a result of a multi-AP operation) are received on the same or overlapping channels. In one case, the two transmission are received simultaneously. In one case, the multi-AP operation may not necessarily result in two transmissions to the STA, but rather involve two APs performing some coordinated action as described herein (e.g., transmitting, not transmitting, etc.). In some cases, both transmissions may have the same receive address of the STA and/or a transmitter address. In some instances, both transmissions may have the same identifier (e.g., association ID, link ID, multi-AP operation ID, entity ID, etc.).

An example of a multi-AP operation may involve more than one AP and a STA. In some cases, one or more of the one or more APs may be affiliated with MLDs (e.g., DMLD, MMLD, MXMLD, etc.). The STA may receive an indication that a first access point (AP) supports multi-AP operations. A multi-AP operation may include, for example, at least one of Seamless BSS Transition, Joint Transmission, Redundant Transmission for Low latency and highly reliable traffic, Coordinated OFDMA, or Coordinated TDMA, Coordinated Beamforming, or any other type described herein. The STA may send a message to the first AP, wherein the message includes a multi-AP operation element (e.g., indicating support for multi-AP operation, and/or requesting multi-AP operation). In one instance, the message is a request for association with the first AP of a MLD, MMLDs, DMLDs or MXMLDs (e.g., whatever the first AP is affiliated with). The STA may receive a response message, wherein the response message indicates a status of a multi-AP operation (e.g., a message to inform the STA whether or not multi-AP operation is possible and/or will be carried out). For example, the status may include an indication that conveys implicitly/explicitly a message of multi-AP operation/association success, reject, or unable to support, and if the status code is success then the AP may indicate the multi-AP operations to be started or to be stopped in the multi-AP operation indication, and/or the APs or identifiers (e.g., link, association, involved entities, etc.) of APs that may participate in the multi-AP operations. In one instance, the response message is part of an association response message received from the first AP (e.g., about the association with the AP, MLD, MMLD, DMLD, MXMLD, etc.). The STA may send a multi-AP operation request (e.g., assuming it has not already performed this, or it is making an additional request, etc.), based on the status of the multi-AP operation. The aforementioned actions may be taken in part, collectively, and/or in a different order than presented with the underlying goal in mind to carry out a message exchange with at least one AP to establish that multi-AP operation is possible and/or desired.

In one example, there may be a method, device, and/or system for distributed multi-link device design for ultra-high reliability situations. In some cases, a wireless receive transmit unit (WTRU), may receive an indication that an access point supports multi-AP operations. The WTRU may send a request for association to the access point, wherein the request for association includes a multi-AP operation element. The WTRU may receive a response to the request for association to the access point, wherein the response indicates a status of the multi-AP operation. The WTRU may send a multi-operation request, based on the status of the multi-AP operation. The WTRU may receive a multi-operation response.

Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although four RBs per triggered TXOP may be an example, the actual number of RBs/channels/bandwidth utilized may vary.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a STA, the method comprising:
receiving an indication that one or more access points (APs) support multi-AP operations;
sending a message to a first AP of the one or more APs, wherein the message includes a multi-AP operation element;
receiving a response message from the first AP, wherein the response message indicates a status of a multi-AP operation;
sending a multi-AP operation request to the first AP, based on the status of the multi-AP operation; and
receiving a multi-AP operation response from the first AP.

2. The method of claim 1, wherein multi-AP operations includes at least one of Seamless BSS Transition, Joint Transmission, Redundant Transmission for Low latency and highly reliable traffic, Coordinated OFDMA, or Coordinated TDMA, or Coordinated Beamforming.

3. The method of claim 2, wherein the response message includes a list of APs or Link IDs of APs that participate in the multi-AP operation.

4. The method of claim 3, wherein a status of the multi-AP operation includes SUCCESS, REJECT, or UNABLE TO SUPPORT.

5. The method of claim 3, wherein the response to the multi-AP operation request includes a list of APs or Link IDs of APs that participate in the multi-AP operation.

6. The method of claim 3, wherein the STA is a multi-link device (MLD) wireless transmit receive unit (WTRU).

7. The method of claim 3, wherein the STA filters out at least a transmission based on a BSS color of the transmission.

8. (canceled)

9. (canceled)

10. A STA comprising:
a processor operatively coupled to a transceiver, the processor and transceiver configured to receive an indication that one or more access points (APs) support multi-AP operations;
the processor and transceiver configured to send a message to a first AP of the one or more APs, wherein the message includes a multi-AP operation element;
the processor and transceiver configured to receive a response message from the first AP, wherein the response message indicates a status of a multi-AP operation;
the processor and transceiver configured to send a multi-AP operation request to the first AP, based on the status of the multi-AP operation; and
the processor and transceiver configured to receive a multi-AP operation response from the first AP.

11. The STA of claim 10, wherein multi-AP operations includes at least one of Seamless BSS Transition, Joint Transmission, Redundant Transmission for Low latency and highly reliable traffic, Coordinated OFDMA, or Coordinated TDMA, or Coordinated Beamforming.

12. The STA of claim wherein the response message includes a list of APs or Link IDs of APs that participate in the multi-AP operation.

13. The STA of claim 12, wherein a status of the multi-AP operation includes SUCCESS, REJECT, or UNABLE TO SUPPORT.

14. The STA of claim 12, wherein the response to the multi-AP operation request includes a list of APs or Link IDs of APs that participate in the multi-AP operation.

15. The STA of claim 12, wherein the STA is a multi-link device (MLD) wireless transmit receive unit (WTRU).

16. The STA of claim 12, wherein the STA filters out at least a transmission based on a BSS color of the transmission.

17. (canceled)

18. (canceled)
